(19) United States
(12) Patent Application Publication
(10) Pub. No.: US 2026/0106143 A1
(43) Pub. Date: Apr. 16, 2026

(54) ALKALI METAL OXIDE AND HYDROXIDE REDUCTION IN THE FILM BY EX-SITU SURFACE PASSIVATED LAYER

(71) Applicant: Applied Materials, Inc., Santa Clara, CA (US)

(72) Inventors: Thomas Humphreys, Santa Clara, CA (US); Girish Kumar Gopalakrishnan Nair, San Jose, CA (US); Subramanya P Herle, Mountain View, CA (US)

(21) Appl. No.: 19/116,258

(22) PCT Filed: Sep. 28, 2023
(86) PCT No.: PCT/US2023/034042

§ 371 Date: Mar. 27, 2025

Related U.S. Application Data
(60) Provisional application No. 63/410,989, filed on Sep. 28, 2022.

(51) Int. Cl. H01M 4/38; H01M 4/02; H01M 4/04; H01M 4/62; H01M 10/0525; H01M 10/0562

(52) U.S. Cl. CPC H01M 4/382; H01M 4/0404; H01M 4/0423; H01M 4/628; H01M 10/0562; H01M 2004/027; H01M 10/0525; H01M 2300/0071

(57) ABSTRACT

Embodiments of the present disclosure include an anode for a battery including a substrate, a metal film disposed on the substrate, and a film stack disposed on the metal film. The film stack includes a lithium carbonate film and a lithium halide film disposed on the lithium carbonate. The lithium carbonate film is disposed on the metal film.

### BACKGROUND

### Field

Embodiments of the present disclosure generally relate to metal electrodes, more specifically lithium-containing electrodes, high performance electrochemical devices, such as secondary batteries, including the aforementioned lithium-containing electrodes, and methods for fabricating the same.

### Description of the Related Art

Rechargeable electrochemical storage systems are increasing in importance for many fields of everyday life. High-capacity energy storage devices, such as lithium-ion (Li-ion) batteries and capacitors, are used in a growing number of applications, including portable electronics, medical, transportation, grid-connected large energy storage, renewable energy storage, and uninterruptible power supply (UPS). In each of these applications, the charge/discharge time and capacity of energy storage devices are key parameters. In addition, the size, weight, and/or cost of such energy storage devices are also key parameters. Further, low internal resistance is beneficial for high performance. The lower the resistance, the less restriction the energy storage device encounters in delivering electrical energy. For example, in the case of a battery, internal resistance affects performance by reducing the total amount of useful energy stored by the battery as well as the ability of the battery to deliver high current.

Li-ion batteries are thought to have the best chance at achieving the sought after capacity and cycling. However, Li-ion batteries as currently constituted often lack the energy capacity and number of charge/discharge cycles for these growing applications.

Accordingly, there is a need in the art for faster charging, higher capacity energy storage devices that have improved cycling, and can be more cost effectively manufactured. There is also a need for components for an energy storage device that reduce the internal resistance of the storage device.

### SUMMARY

In one embodiment, an anode for a battery is disclosed. The anode includes a substrate, a metal film disposed on the substrate, and a solid electrolyte interphase (SEI) film stack disposed on the metal film. The SEI film stack includes a first passivation layer disposed on the metal film and a second passivation layer disposed on the first passivation layer.

In another embodiment, an energy storage device is disclosed. The energy storage device includes a cathode, a separator film, and an anode. The cathode includes a cathode current collector and a cathode film disposed on the cathode current collector. The separator film disposed on the cathode film. The anode is disposed on the separator film. The anode includes an anode film disposed on the separator film, a solid electrolyte interphase (SEI) film stack disposed on the anode film, and an anode current collector disposed on the anode film. The SEI film stack includes a first passivation layer disposed on the anode film and a second passivation layer disposed on the first passivation layer.

In another embodiment, a method of forming an anode for a battery is disclosed. The method includes disposing a metal film over a substrate and disposing a solid electrolyte interphase (SEI) film stack over the metal film. The disposing of the SEI film stack includes disposing a first film over the metal film and disposing a second film over the first film. The first film is a lithium carbonate film. The second film is a lithium halide film.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 is a schematic, cross-sectional view of an energy storage device, according to embodiments.

FIG. 2 is a schematic, cross-sectional view of a dual-sided anode electrode, according to embodiments.

FIG. 3 is a schematic, cross-sectional view of a dual-sided anode electrode, according to embodiments.

FIG. 4 is a schematic cross-sectional view of a metal anode, according to embodiments.

FIG. 5 is a flow diagram of a method of forming a metal anode, according to embodiments.

FIG. 6A-6F are schematic, cross-sectional views of a portion of a metal anode during a method of forming the metal anode, according to embodiments.

FIG. 7 is a schematic view of an integrated processing tool for forming a metal anode, according to embodiments.

FIG. 8 is a flow diagram of a method of forming a metal anode using a transfer substrate, according to embodiments.

FIG. 9A-9B are graphs illustrating the X-Ray Photoelectron Spectroscopy (XPS) depth profiling of an SEI film stack lithium anode sample, according to embodiments.

FIG. 10 illustrates a modified interface metal anode, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The following disclosure describes lithium-containing electrodes, high performance electrochemical devices, such as secondary batteries, including the aforementioned lithium-containing electrodes, and methods for fabricating the same.

Many of the details, dimensions, angles and other features shown in the Figures are merely illustrative of particular embodiments. Accordingly, other embodiments can have other details, components, dimensions, angles and features without departing from the spirit or scope of the present disclosure. In addition, further embodiments of the disclosure can be practiced without several of the details described below.

Embodiments described herein will be described below in reference to a roll-to-roll coating system. Other tools capable of performing high rate deposition processes may also be adapted to benefit from the embodiments described herein. In addition, any system enabling the deposition processes described herein can be used to advantage. The apparatus description described herein is illustrative and should not be construed or interpreted as limiting the scope of the embodiments described herein. It should also be understood that although described as a roll-to-roll process, the embodiments described herein may also be performed on discrete substrates.

Development of rechargeable lithium metal batteries is considered a promising technology, which can enable a high-energy-density system for energy storage. However, current lithium metal batteries suffer from dendrite growth, which hinders the practical applications of lithium metal batteries in portable electronics and electric vehicles. Over the course of several charge/discharge cycles, microscopic fibers of lithium, called dendrites form on the lithium metal surface and spread until contacting the other electrode. Passing electrical current through these dendrites can short circuit the battery. One of the most challenging aspects of enabling lithium metal battery technology is the development of a stable and efficient solid electrolyte interphase (SEI). A stable and efficient SEI provides an effective strategy for inhibiting dendrite growth and thus achieving improved cycling.

Current SEI films are typically formed in-situ during the cell formation cycling process, which is generally performed immediately after cell fabrication. During the cell formation cycling process, when an appropriate potential is established on the anode and particular organic solvents are used as the electrolyte, the organic solvent is decomposed and forms the SEI film at first charge. With typical liquid electrolytes and under lower current density, a lithium was deposited and the lithium growth was attributed to “bottom growth.” At higher current densities, a concentration gradient in the electrolyte causes ‘tip growth’ and this tip growth causes shorting of the cell. Depending upon the organic solvents used, the SEI film that forms on the anode is typically a mixture of lithium oxide, lithium halides, and semicarbonates. Initially, the SEI film is electrically insulating yet sufficiently conductive to lithium ions. The SEI prevents decomposition of the electrolyte after the second charge. The SEI can be thought of as a three-layer system with two key interfaces. In conventional electrochemical studies, it is often referred to as an electrical double layer. In its simplest form, an anode coated by an SEI will undergo three stages when charged. These three stages include electron transfer between the anode (M) and the SEI (M⁰−ne→Mⁿ⁺_{M/SEI}); cation migration from the anode-SEI interface to the SEI-electrolyte (E) interface (Mⁿ⁺_{M/SEI→M}ⁿ⁺_{SEI/E}); and cation transfer in the SEI to electrolyte at the SEI/electrolyte interface (E(solv)+Mⁿ⁺_{SEI/E}→Mⁿ⁺E(solv)).

The power density and recharge speed of the battery is dependent on how quickly the anode can release and gain charge. This, in turn, is dependent on how quickly the anode can exchange lithium ions with the electrolyte through the SEI. Lithium ion exchange at the SEI is a multi-stage process and as with most multi-stage processes, the speed of the entire process is dependent upon the slowest stage. The anion migration may be the bottleneck for most systems. In addition, the diffusive characteristics of the solvents may dictate the speed of migration between the anode-SEI interface and the SEI-electrolyte (E) interface. Thus, the best solvents have low mass in order to maximize the speed of diffusion.

The specific properties and reactions that take place at the SEI may have an effect on the cycling and capacity of the anode electrode structure. The SEI may thicken when cycled, slowing diffusion from the Electrode/SEI interface to the SEI/Electrolyte. For example, at elevated temperatures, alkyl carbonates in the electrolyte decompose into insoluble Li₂CO₃, which may increase the thickness of the SEI film, clog pores of the SEI film, and limit lithium ion access to the anode. SEI growth may also occur by gas evolution at the cathode and particle migration towards the anode, increasing impedance and decreasing capacity. Further, the randomness of metallic lithium embedded in the anode during intercalation may result in dendrite formation. Over time, the dendrites pierce the separator, causing a short circuit, leading to heat, fire and/or explosion.

Embodiments of the present disclosure relate to constructing a stable and an efficient SEI film ex-situ. The SEI film is formed in the energy storage device during fabrication of the energy storage device. This new and efficient SEI film is believed to inhibit lithium dendrite growth and thus achieves superior lithium metal cycling performance relative to current lithium based anodes, which rely on an in-situ SEI film.

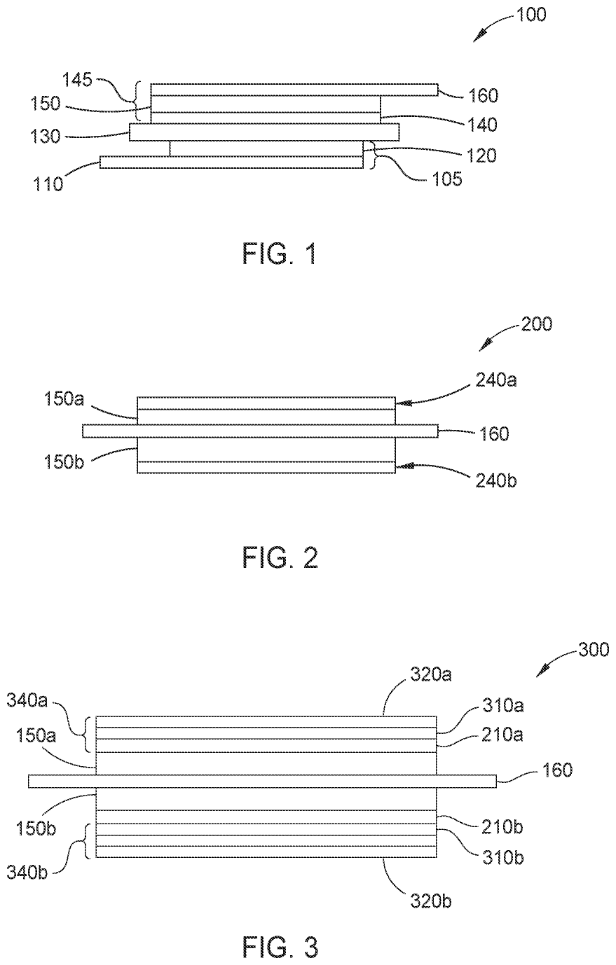

FIG. 1 illustrates a cross-sectional view of one embodiment of an energy storage device 100 incorporating an anode electrode structure having an SEI film stack 140 formed according to embodiments described herein. In some embodiments, the energy storage device 100 is a rechargeable battery cell. In some embodiments, the energy storage device 100 is combined with other cells to form a rechargeable battery. The energy storage device 100 has a cathode 105, an anode 145, and a separator film 130. The cathode 105 includes a cathode current collector 110 and a cathode film 120. The anode 145 includes the SEI film stack 140, an anode film 150, and an anode current collector 160. Note in FIG. 1 that the cathode current collector 110, anode current collector 160, and separator film 130 are shown to extend beyond the stack, although it is not necessary for the cathode current collector 110 and anode current collector 160 to extend beyond the stack, the portions extending beyond the stack may be used as tabs. The SEI film stack 140 can have more than one layer, for example, a lithium carbonate film in combination with lithium fluoride (LiF).

In one embodiment, portions of the SEI film stack 140 are formed by exposing a lithium film to an SF₆ gas treatment to form LiF and Li₂S portions of the SEI film stack 140 on the surface of the lithium film. The SF₆ gas can be activated to react with the exposed lithium surface either thermally or SF₆ gas can be plasma activated. The thickness of the SEI film stack 140 can be controlled by modifying the SF₆ gas exposure time and temperature.

The cathode current collector 110 and anode current collector 160, on the cathode film 120 and the anode film 150, respectively, can be identical or different electronic conductors. Examples of metals that the cathode current collector 110 and anode current collector 160 may be comprised of include aluminum (Al), copper (Cu), zinc (Zn), nickel (Ni), cobalt (Co), tin (Sn), silicon (Si), manganese (Mn), magnesium (Mg), alloys thereof, and combinations thereof. In one embodiment, at least one of the current collectors 110, 160 is perforated. Furthermore, current collectors may be of any form factor (e.g., metallic foil, sheet, or plate), shape and micro/macro structure. In one embodiment, at least one of the current collectors 110, 160 include a polyethylene terephthalate (“PET”) film coated with a metallic material. In one embodiment, the anode current collector 160 is a PET film coated with copper. In another embodiment, the anode current collector 160 is a multi-metal layer on PET. The multi-metal layer can be combinations of copper, chromium, nickel, etc. In one embodiment, the anode current collector 160 is a multi-layer structure that includes a copper-nickel cladding material. In one embodiment, the multi-layer structure includes a first layer of nickel or chromium, a second layer of copper formed on the first layer, and a third layer including nickel, chromium, or both formed on the second layer. In one embodiment, the anode current collector 160 is nickel coated copper. Furthermore, current collectors may be of any form factor (e.g., metallic foil, sheet, or plate), shape and micro/macro structure. Generally, in prismatic cells, tabs are formed of the same material as the current collector and may be formed during fabrication of the stack, or added later. All components except current collectors 110 and 160 contain lithium ion electrolytes. In one embodiment, the cathode current collector 110 is aluminum. In one embodiment, the cathode current collector 110 has a thickness from about 0.5 μm to about 20 μm (e.g., from about 1 μm to about 10 μm; from about 5 μm to about 10 μm). In one embodiment, the anode current collector 160 is copper. In one embodiment, the anode current collector 160 has a thickness from about 0.5 μm to about 20 μm (e.g., from about 1 μm to about 10 μm; from about 2 μm to about 8 μm; from about 5 μm to about 10 μm).

The anode film 150 or anode may be any material compatible with the cathode film 120 or cathode. The anode film 150 may have an energy capacity greater than or equal to 372 mAh/g, preferably ≥700 mAh/g, and most preferably ≥1000 mAh/g. The anode film 150 may be constructed from lithium metal, lithium metal foil or a lithium alloy foil (e.g. lithium aluminum alloys), or a mixture of a lithium metal and/or lithium alloy and materials such as carbon (e.g. coke, graphite), nickel, copper, tin, indium, silicon, oxides thereof, or combinations thereof. The anode film 150 typically comprises intercalation compounds containing lithium or insertion compounds containing lithium. In some embodiments, wherein the anode film 150 comprises lithium metal, the lithium metal may be deposited using the methods described herein. The anode film 150 may be formed by extrusion, physical or chemical thin-film techniques, such as sputtering, electron beam evaporation, chemical vapor deposition (CVD), three-dimensional printing, lithium powder deposition, etc. In one embodiment, the anode film 150 has a thickness from about 0.5 μm to about 20 μm (e.g., from about 1 μm to about 10 μm; from about 5 μm to about 10 μm). In one embodiment, the anode film 150 is a lithium metal or lithium metal alloy film.

The SEI film stack 140 is formed ex-situ on the anode film 150. The SEI film stack 140 is electrically insulating yet sufficiently conductive to lithium-ions. In one embodiment, the SEI film stack 140 is a nonporous film. In another embodiment, the SEI film stack 140 is a porous film. In one embodiment, the SEI film stack 140 has a plurality of nanopores that are sized to have an average pore size or diameter less than about 10 nanometers (e.g., from about 1 nanometer to about 10 nanometers; from about 3 nanometers to about 5 nanometers). In another embodiment, the SEI film stack 140 has a plurality of nanopores that are sized to have an average pore size or diameter less than about 5 nanometers. In one embodiment, the SEI film stack 140 has a plurality of nanopores having a diameter ranging from about 1 nanometer to about 20 nanometers (e.g., from about 2 nanometers to about 15 nanometers; or from about 5 nanometers to about 10 nanometers).

The SEI film stack 140 may be a coating or a discrete layer, either having a thickness in the range of 1 nanometer to 200 nanometers (e.g., in the range of 5 nanometers to 200 nanometers; in the range of 10 nanometers to 50 nanometers). Not to be bound by theory, but it is believed that SEI films greater than 200 nanometers may increase resistance within the rechargeable battery.

Examples of materials that may be included in the SEI film stack 140 include, but are not limited to a chalcogenide film (e.g., CuS, Cu₂Se, Cu₂S, Cu₂Te, CuTe, Bi₂Te₃, or Bi₂Se₃ film) or composite chalcogenide film optionally in combination with at least one of a lithium carbonate (Li₂CO₃) film, a lithium oxide (Li₂O) film, a lithium nitride film (Li₃N), and a lithium halide film (e.g. LiF, LiCl, LiBr, or LiI). Not to be bound by theory but it is believed that the SEI film stack 140 can take-up Li-conducting electrolyte to form gel during device fabrication which is beneficial for forming good solid electrolyte interface (SEI) and also helps lower resistance. Suitable methods for depositing portions of the SEI film stack 140 directly on the metal film include, but are not limited to, Physical Vapor Deposition (PVD), such as evaporation or sputtering, a slot-die process, a thin-film transfer process, or a three-dimensional lithium printing process. Portions of the SEI film stack may be formed by plasma treatment of previously deposited layers (e.g., oxygen plasma treatment of an exposed lithium surface to form a lithium oxide film).

The cathode film 120 or cathode may be any material compatible with the anode and may include an intercalation compound, an insertion compound, or an electrochemically active polymer. Suitable intercalation materials include, for example, lithium-containing metal oxides, MoS₂, FeS₂, MnO₂, TiS₂, NbSe₃, LiCoO₂, LiNiO₂, LiMnO₂, LiMn₂O₄, V₆O₁₃, and V₂O₅. Suitable polymers include, for example, polyacetylene, polypyrrole, polyaniline, and polythiophene. The cathode film 120 or cathode may be made from a layered oxide, such as lithium cobalt oxide, an olivine, such as lithium iron phosphate, or a spinel, such as lithium manganese oxide. Exemplary lithium-containing oxides may be layered, such as lithium cobalt oxide (LiCoO₂), or mixed metal oxides, such as LiNiₓCo₁₋₂ₓMnO₂, LiNiMnCoO₂ (“NMC”), LiNi_{0.5}Mn_{1.5}O₄, Li(Ni_{0.8}CO_{0.15}Al_{0.05})O₂, LiMn₂O₄, and doped lithium rich layered-layered materials, wherein x is zero or a non-zero number. Exemplary phosphates may be iron olivine (LiFePO₄) and it is variants (such as LiFe₍₁₋ₓ₎MgₓPO₄, wherein x is between 0 and 1), LiMoPO₄, LiCoPO₄, LiNiPO₄, Li₃V₂(PO₄)₃, LiVOPO₄, LiMP₂O₇, or LiFe_{1.5}P₂O₇, wherein x is zero or a non-zero number. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃. The cathode film 120 may be formed by physical or chemical thin-film techniques, such as sputtering, electron beam evaporation, chemical vapor deposition (CVD), etc. In one embodiment, the cathode film 120 has a thickness from about 10 μm to about 100 μm (e.g., from about 30 μm to about 80 μm; or from about 40 μm to about 60 μm). In one embodiment, the cathode film 120 is a LiCoO₂ film. In another embodiment, the cathode film 120 is an NMC film.

The separator film 130 comprises a porous (e.g., microporous) polymeric substrate capable of conducting ions (e.g., a separator film) with pores. In some embodiments, the porous polymeric substrate itself does not need to be ion conducting, however, once filled with electrolyte (liquid, gel, solid, combination etc.), the combination of porous substrate and electrolyte is ion conducting. In one embodiment, the porous polymeric substrate is a multi-layer polymeric substrate. In one embodiment, the pores are micropores. In some embodiments, the porous polymeric substrate consists of any commercially available polymeric microporous membranes (e.g., single-ply or multi-ply), for example, those products produced by Polypore (Celgard Inc., of Charlotte, North Carolina), Toray Tonen (Battery separator film (BSF)), SK Energy (Li-ion battery separator (LiBS), Evonik industries (SEPARION® ceramic separator membrane), Asahi Kasei (Hipore™ polyolefin flat film membrane), DuPont (Energain®), etc. In some embodiments, the porous polymeric substrate has a porosity in the range of 20 to 80% (e.g., in the range of 28 to 60%). In some embodiments, the porous polymeric substrate has an average pore size in the range of 0.02 to 5 microns (e.g., 0.08 to 2 microns). In some embodiments, the porous polymeric substrate has a Gurley Number in the range of 15 to 150 seconds (Gurley Number refers to the time it takes for 10 cc of air at 12.2 inches of water to pass through one square inch of membrane). In some embodiments, the porous polymeric substrate is polyolefinic. Exemplary polyolefins include polypropylene, polyethylene, or combinations thereof.

In some embodiments of the energy storage device of the present disclosure, lithium is contained in the metal film of the anode electrode, and lithium manganese oxide (LiMnO4) or lithium cobalt oxide (LiCoO2) at the cathode electrode, for example, although in some embodiments, the anode electrode may also include lithium absorbing materials such as silicon, tin, etc. The energy storage device, even though shown as a planar structure, may also be formed into a cylinder by rolling the stack of layers; furthermore, embodiments of the present disclosure also contemplate other cell configurations (e.g., prismatic cells, button cells).

Electrolytes infused in cell components (i.e., cathode current collector 110, separator film 130, SEI film stack 140, and anode current collector 160) can be comprised of a liquid/gel or a solid polymer and may be different in each. In some embodiments, the electrolyte primarily includes a salt and a medium (e.g., in a liquid electrolyte, the medium may be referred to as a solvent; in a gel electrolyte, the medium may be a polymer matrix). The salt may be a lithium salt. The lithium salt may include, for example, LiPF₆, LiAsF₆, LiCF₃SO₃, LiN(CF₃SO₃)₃, LiBF₆, and LiClO₄, lithium bistrifluoromethanesulfonimidate (e.g., LiTFSI), BETTE electrolyte (commercially available from 3M Corp. of Minneapolis, MN) and combinations thereof. Solvents may include, for example, ethylene carbonate (EC), propylene carbonate (PC), EC/PC, 2-MeTHF(2-methyltetrahydrofuran)/EC/PC, EC/DMC (dimethyl carbonate), EC/DME (dimethyl ethane), EC/DEC (diethyl carbonate), EC/EMC (ethyl methyl carbonate), EC/EMC/DMC/DEC, EC/EMC/DMC/DEC/PE, PC/DME, and DME/PC. Polymer matrices may include, for example, PVDF (polyvinylidene fluoride), PVDF:THF (PVDF:tetrahydrofuran), PVDF:CTFE (PVDF:chlorotrifluoroethylene) PAN (polyacrylonitrile), and PEO (polyethylene oxide).

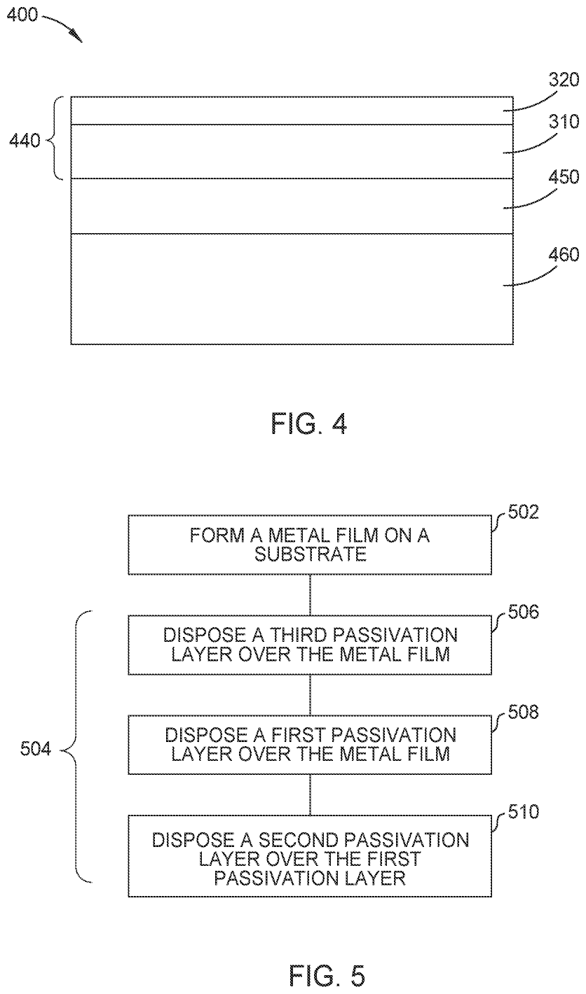

FIG. 2 illustrates a cross-sectional view of one embodiment of a dual-sided anode electrode structure 200 having a solid electrolyte interphase (SEI) film stack 240a, 240b (collectively 240) formed according to embodiments described herein. The dual-sided anode electrode structure 200 may be used in place of the anode 145 depicted in FIG. 1. The SEI film stack 240a, 240b may be used in place of the SEI film stack 140 depicted in FIG. 1. Each SEI film stack 240a, 240b includes a first passivation layer and a second passivation layer. The first passivation layer includes is disposed on the anode film 150a, 150b. The first passivation layer includes a lithium carbonate layer. The second passivation layer is disposed on the first passivation layer. The second passivation layer includes a dielectric film. The dielectric film may include a lithium halide, such as LiF, LiCl, LiBr, or LiI.

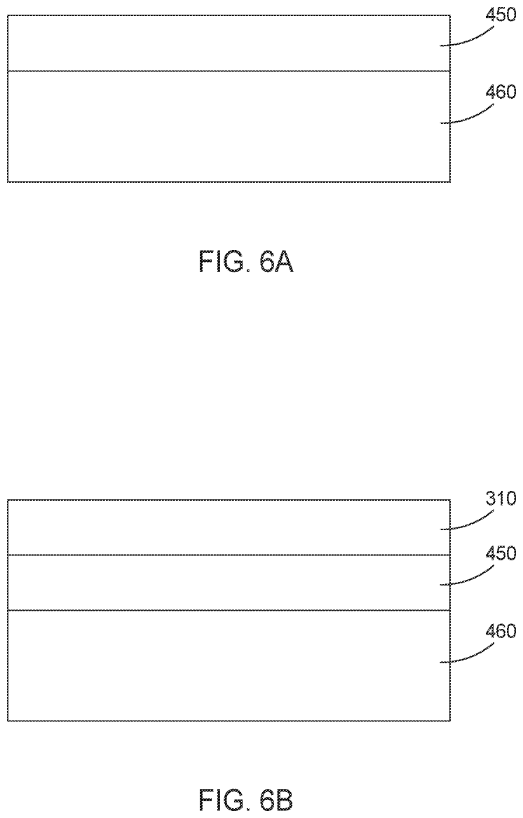

FIG. 3 illustrates a cross-sectional view of another embodiment of a dual-sided anode electrode structure 300 having a solid electrolyte interphase (SEI) film stack 340a, 340b (collectively 340) formed according to embodiments described herein. The dual-sided anode electrode structure 300 may be used in place of the anode 145 depicted in FIG. 1. The SEI film stack 340a, 340b may be used in place of the SEI film stack 140 depicted in FIG. 1. Each SEI film stack 340a, 340b includes a third passivation layer. The third passivation layer includes a lithium oxide film 210a, 210b respectively disposed over each anode film 150a, 150b. Each SEI film stack 340a, 340b further includes a first passivation layer disposed over the lithium oxide film 210a, 210b. The first passivation layer includes lithium carbonate film 310a, 310b (collectively 310). Each SEI film stack 340a, 340b further includes a second passivation layer disposed over the first passivation layer. The second passivation layer includes a dielectric film (e.g., lithium halide film 320a, 320b) (collectively 320).

Note in FIGS. 2 & 3 that the anode current collector 160 is shown to extend beyond the stack, although it is not necessary for the anode current collector 160 to extend beyond the stack, the portions extending beyond the stack may be used as tabs. Although the anode electrode structures depicted in FIGS. 2-3 are depicted as dual-sided electrode structures, it should be understood that the embodiments described in FIGS. 2-3 also apply to single-sided electrode structures.

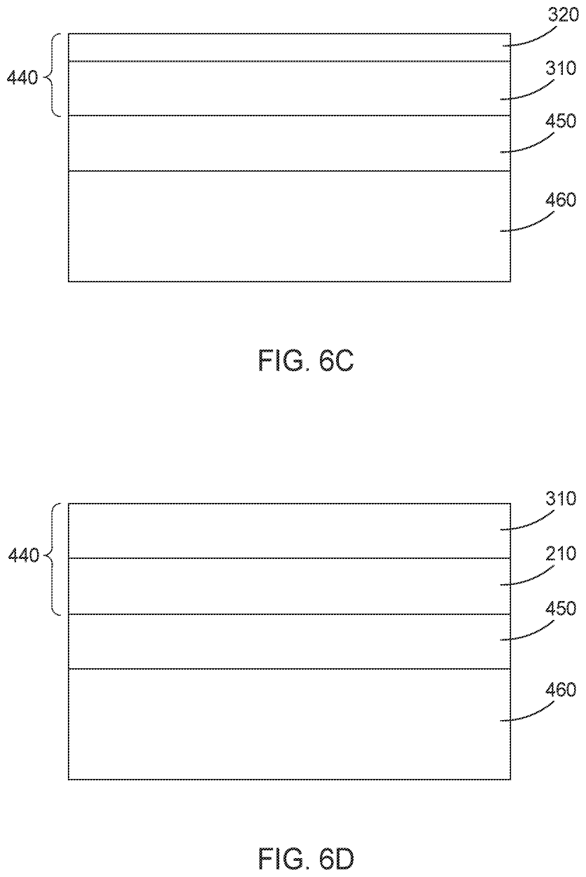

FIG. 4 illustrates an embodiment of a metal anode 400 of an energy storage device 100. The metal anode 400 includes a substrate 460, a metal film 450, and a SEI film stack 440. In one embodiment, the metal film 450 is the anode film 150 and the substrate 460 is the anode current collector 160. In some embodiments, the metal film is a metal film. In some embodiments, the metal film comprises a metal or a metal alloy, such as lithium. In one embodiment, the metal film 450 is disposed over a copper substrate 460. In some embodiments, if an anode film 150 is already present on the substrate 460, the metal film 450 is disposed over the anode film 150. If the anode film 150 is not present, the metal film 450 may be disposed directly on the substrate 460. Any suitable metal deposition process for depositing thin films of metal may be used to deposit the metal film 450. Deposition of the metal film 450 may be by evaporation, a sputtering process, a slot-die process, a transfer process, or a three-dimensional lithium printing process. The chamber for depositing the thin film of metal may include a PVD system, an electron-beam evaporator, a thermal evaporator, a thin film transfer system (including large area pattern printing systems such as gravure printing systems) or a slot-die deposition system. In one embodiment, the metal film 450 has a thickness of 100 micrometers or less (e.g., from about 1 μm to about 100 μm; from about 3 μm to about 30 μm; from about 20 μm to about 30 μm; from about 1 μm to about 20 μm; or from about 50 μm to about 100 μm). In one embodiment, the substrate 402 has a thickness between about 10 μm and about 100 μm, such as about 18 μm.

The SEI film stack 440 further includes at least a first passivation layer and a second passivation layer. The SEI film stack includes materials that are electrically insulating (e.g., dielectric materials) and ionically conducting. In the illustrated embodiment, the first passivation layer is the lithium carbonate (Li₂CO₃) film 310 and the second passivation layer is the lithium halide film 320. The first passivation layer may include a lithio-philic material. The first passivation layer may also include a dielectric material (e.g., an electrically insulating material). The second passivation layer may include a dielectric material (e.g., an electrically insulating material). The lithium halide film may include e.g. LiF, LiCl, LiBr, or LiI. In one embodiment, the SEI film stack 440 includes a third passivation layer between the lithium carbonate film 310 and the metal film 450. In one embodiment, the lithium carbonate film 310 has a thickness of about 200 nm or less (e.g., from about 5 nm to about 200 nm; from about 20 nm to about 150 nm; from about 40 nm to about 100 nm; from about 60 nm to about 80 nm). In one embodiment, the lithium halide film 320 has a thickness of about 15 nm or less (e.g., from about 1 nm to about 15 nm; from about 5 to about 10 nm; from about 10 nm to about 15 nm). In some embodiment, the first passivation layer and second passivation layer are not distinct layers. E.g., the lithium carbonate layer and the lithium halide layer have a blended region at the interface of the lithium carbonate and lithium halide. In embodiments including the third passivation layer, the first passivation layer and third passivation layer are not distinct layers. E.g., the lithium carbonate layer and the lithium oxide layer have a blended region at the interface of the lithium carbonate and lithium oxide.

The lithium carbonate film 310 is deposited onto the metal film 450. In one embodiment, the substrate 460 coated in the metal film 450 is wound past a modular gas showerhead, exposing the metal film 450 to carbon dioxide (CO₂). The exposure to CO₂ leads to the formation of a lithium carbonate film 310 on the metal film 450. The lithium halide film 320 is deposited onto the lithium carbonate film 310. The deposition of the lithium halide film 320 can be done using one of, sputter deposition, electron beam evaporation, ion beam deposition, or resistive thermal evaporation. By creating a SEI film stack 440 including lithium halide film 320 and lithium carbonate film 310, improvements in cell cycling performance, interfacial properties, and electrochemical properties are achieved. Further, as will be discussed further below, the use of lithium halide leads to a decreased amount of lithium oxide in the anode 400.

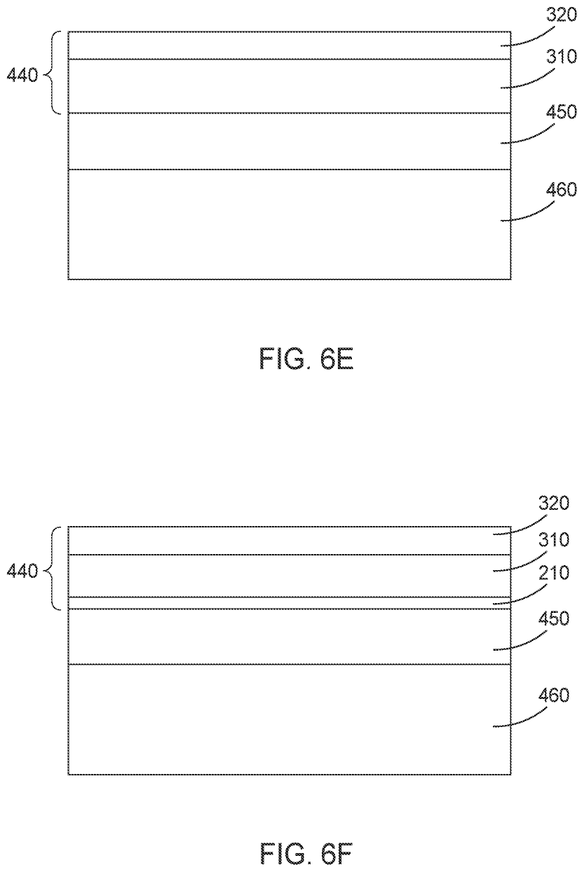

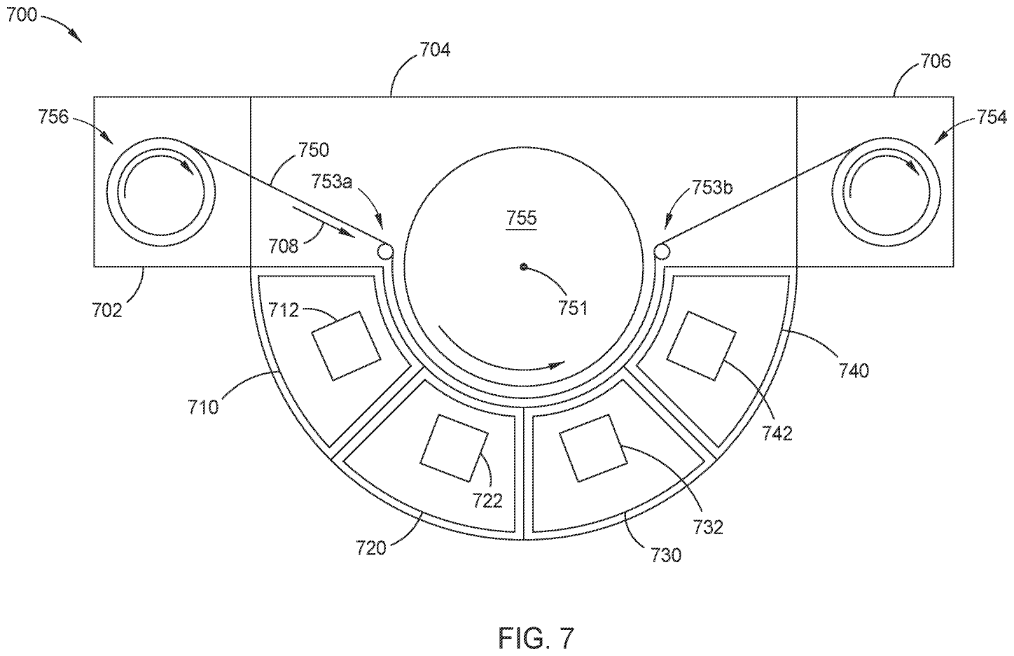

FIG. 5 is a flow diagram of a method 500 of forming a anode 400 of an energy storage device 100, as shown in FIG. 4. FIGS. 6A-6F are schematic, cross-sectional views of the anode 400 during the method of forming an anode 400.

At operation 502, a metal film 450 is disposed over the substrate 460 as shown in FIG. 6A. In one embodiment, the metal film 450 is the anode film 150 and the substrate 460 is the anode current collector 160. In one embodiment, the substrate 460 is a continuous sheet of material. The substrate 460 includes one of aluminum (Al), copper (Cu), zinc (Zn), nickel (Ni), cobalt (Co), manganese (Mn), chromium (Cr), stainless steel, clad materials, alloys thereof, and combinations thereof. In one embodiment, the substrate 460 is perforated. Furthermore, the substrate 460 may be of any form factor (e.g., metallic foil, sheet, or plate), shape and micro/macro structure.

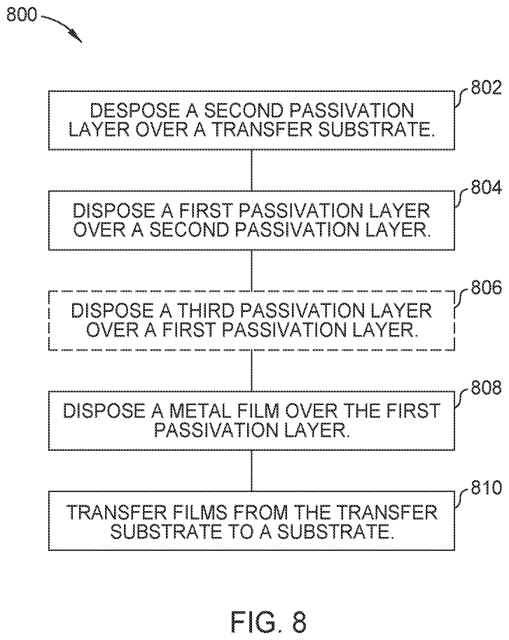

The metal film 450 is deposited on the substrate 460 using a flexible substrate coating apparatus 700, which is describe with respect to FIG. 7. The copper substrate 460 is fed through the flexible substrate coating apparatus 700, where lithium is thermally evaporated onto the copper substrate 460 to create the metal film 450. In some embodiments, if an anode film 150 is already present on the substrate 460, the metal film 450 is disposed over the anode film 150. If the anode film 150 is not present, the metal film 450 may be disposed directly on the substrate 460. Any suitable metal film deposition process for depositing thin films of metal may be used to deposit the metal film 450. Deposition of the metal film 450 may be by evaporation, a sputtering process, a slot-die process, a transfer process, or a three-dimensional lithium printing process. The chamber for depositing the metal film 450 may include a PVD system, an electron-beam evaporator, a thermal evaporator, a thin film transfer system (including large area pattern printing systems such as gravure printing systems) or a slot-die deposition system. In one embodiment, the metal film 450 has a thickness of 100 micrometers or less (e.g., from about 1 μm to about 100 μm; from about 3 μm to about 30 μm; from about 20 μm to about 30 μm; from about 1 μm to about 20 μm; or from about 50 μm to about 100 μm).

In some embodiments, a transfer substrate could be used. The transfer substrate could be flexible plastic film (e.g., polyethylene terephthalate (PET), polyethylene (PE), polypropylene (PP), polyimide (PI), etc.). In some embodiments, the transfer substrate may be coated with an organic or inorganic functional layer or layers which may be selectively transferred or aid selective transfer of metal film (e.g., PDMS, boron nitride, aluminum oxide (AlOₓ), polytetrafluoroethylene (PTFE), fluorinated ethylene propylene (FEP), perfluorooctanoic acid (PFOA), polyvinylidene (PVDF), etc.). The metal and dielectric layers are then deposited onto this plastic substrate and subsequently transferred by lamination onto the desired device architecture, such as a current collector or substrate 460 (e.g., copper (Cu) and metallized plastic such as cu on PET). In one embodiment, the transfer substrate has a thickness of 200 microns or less, such as from 5 microns to about 100 microns, from about 10 microns to about 75 microns, or from about 20 microns to about 50 microns.

In some embodiments, the substrate 460 is exposed to a pretreatment process, which includes at least one of a plasma treatment or corona discharge process to remove organic materials from the exposed surfaces of the substrate 460. The pretreatment process is performed prior to film deposition on the substrate 460.

At operation 504, an SEI film stack 440 is disposed over the metal film 450. The SEI film stack 440 includes a lithium carbonate (Li₂CO₃) film and lithium halide film. Operation 504 may be divided into optional operation 506, operation 508, and operation 510. Optionally, at operation 506, a lithium oxide (Li₂O) film 210 is disposed over the metal film 450. In one embodiment, the lithium oxide film 210 has a thickness of 500 nanometers or less (e.g., from about 1 nm to about 400 nm; from about 25 nm to about 300 nm; from about 50 nm to about 200 nm; or from about 100 nm to about 150 nm). In one embodiment, the lithium oxide film 210 is formed by depositing an additional metal film via PVD in an oxygen-containing atmosphere.

At operation 508, a first passivation layer is disposed over the metal film 450, as shown in FIG. 6C. The first passivation layer includes a lithium carbonate film 310. In one embodiment, the lithium carbonate film 310 has a thickness of about 200 nm or less (e.g., from about 5 nm to about 200 nm; from about 20 nm to about 150 nm; from about 40 nm to about 100 nm; from about 60 nm to about 80 nm).

Optionally, the lithium carbonate (Li₂CO₃) film is disposed over a third passivation layer. The third passivation layer is a lithium oxide film 210, as shown in FIG. 6D. In one embodiment, the lithium carbonate film 310 has a thickness of about 200 nm or less (e.g., from about 5 nm to about 200 nm; from about 20 nm to about 150 nm; from about 40 nm to about 100 nm; from about 60 nm to about 80 nm). In one embodiment, the lithium carbonate film 310 is formed by depositing an additional metal film on the lithium oxide film 210 and exposing the metal film 450 to a plasma process (e.g., gas treatment using at least one of O₂ and CO₂) to oxidize the metal film 450. In one embodiment, the lithium oxide film 210 is formed by depositing an additional metal film via PVD in an oxygen-and-carbon-containing atmosphere. In one embodiment, portions of the lithium oxide film 210 deposited during operation 508 are exposed to a plasma process to form the lithium carbonate film 310.

At operation 510, a second passivation layer is disposed over the lithium carbonate film 310, as shown in FIG. 6E. The second passivation layer includes a dielectric layer, such as a lithium halide film 320. In one embodiment, the lithium halide film is selected from LiF, LiCl, LiBr, and LiI. In one embodiment, the lithium halide film 320 is a lithium fluoride film. In one embodiment, the lithium halide film 320 is deposited on the lithium carbonate film 310 by Physical Vapor Deposition (PVD), evaporation, atomic layer deposition (ALD), a slot-die process, a thin-film transfer process, or a three-dimensional lithium printing process. In one embodiment, PVD is the method for deposition of the lithium halide film 320. In one embodiment, the lithium halide film 320 is deposited using a thermal evaporation process. In one embodiment, the lithium halide film is formed by reduction of a functional layer or surface functional groups on the plastic substrate used for metal deposition. This halide/organic layer will then be present on the metal film 450 surface following lamination to the substrate 460. In one embodiment, the lithium halide film 320 has a thickness of about 15 nm or less (e.g., from about 1 nm to about 15 nm; from about 5 to about 10 nm; from about 10 nm to about 15 nm).

Optionally, the lithium halide film 320 is disposed over the lithium carbonate (Li₂CO₃) film 310, which is disposed over the lithium oxide film 210, as shown in FIG. 6F. In one embodiment, the lithium halide film 320 is deposited on the lithium carbonate film 310 by Physical Vapor Deposition (PVD), evaporation, atomic layer deposition (ALD), a slot-die process, a thin-film transfer process, or a three-dimensional lithium printing process. In one embodiment, PVD is the method for deposition of the lithium halide film 320. In one embodiment, the lithium halide film 320 is deposited using a thermal evaporation process. In one embodiment, the lithium halide film 320 has a thickness of about 15 nm or less (e.g., from about 1 nm to about 15 nm; from about 5 to about 10 nm; from about 10 nm to about 15 nm). During deposition of the lithium halide film 320 onto the lithium carbonate film 310, the thickness of the lithium oxide film 210 decreases. In one embodiment, the lithium oxide film 210 decreases to a thickness small enough that the lithium oxide film 210 is not detectable using spectroscopy.

FIG. 7 illustrates a schematic view of a flexible substrate coating apparatus 700 for forming anode electrode structures according to embodiments described herein. According to typical embodiments, the flexible substrate coating apparatus 700 can be used for manufacturing lithium anodes, and particularly for SEI film stacks 440 for anode 400. The flexible substrate coating apparatus 700 is constituted as a roll-to-roll system including an unwinding module 702, a processing module 704 and a winding module 706. In certain embodiments, the processing module 704 comprises a plurality of processing modules or chambers 710, 720, 730 and 740 arranged in sequence, each configured to perform one processing operation to the continuous sheet of material 750 or web of material. In one embodiment, as depicted in FIG. 7, the processing chambers 710-740 are radially disposed about a coating drum 755. Arrangements other than radial are contemplated. For example, in another embodiment, the processing chambers may be positioned in a linear configuration.

In one embodiment, the processing chambers 710-740 are stand-alone modular processing chambers wherein each modular processing chamber is structurally separated from the other modular processing chambers. Therefore, each of the stand-alone modular processing chambers, can be arranged, rearranged, replaced, or maintained independently without affecting each other. Although four processing chambers 710-740 are shown, it should be understood that any number of processing chambers may be included in the flexible substrate coating apparatus 700.

The processing chambers 710-740 may include any suitable structure, configuration, arrangement, and/or components that enable the flexible substrate coating apparatus 700 to deposit an anode according to embodiments of the present disclosure. For example, but not limited to, the processing chambers may include suitable deposition systems including coating sources, power sources, individual pressure controls, deposition control systems, and temperature control. According to typical embodiments, the chambers are provided with individual gas supplies. The chambers are typically separated from each other to provide good gas separation. The flexible substrate coating apparatus 700 according to embodiments described herein is not limited in the number of deposition chambers. For example, but not limited to, flexible substrate coating apparatus 700 may include 3, 6, or 12 processing chambers.

The processing chambers 710-740 typically include one or more deposition units 712, 722, 732, and 742. Generally, the one or more deposition units as described herein can be selected from the group of a CVD or ALD source, a PECVD source, and a PVD source. The one or more deposition units can include an evaporation source, a sputter source, such as, a magnetron sputter source, a DC sputter source, an AC sputter source, a pulsed sputter source, a radio frequency (RF) sputtering source, or a middle frequency (MF) sputtering source. For instance, MF sputtering with frequencies in the range of 5 kHz to 100 kHz, for example, 30 kHz to 50 kHz, can be provided. The one or more deposition units can include an evaporation source. In one embodiment, the evaporation source is a thermal evaporation source or an electron beam evaporation source. In one embodiment, the evaporation source is a lithium (Li) source. Further, the evaporation source may also be an alloy of two or more metals. The material to be deposited (e.g., lithium) can be provided in a crucible. The lithium can, for example, be evaporated by thermal evaporation techniques or by electron beam evaporation techniques.

In some embodiments, any of the processing chambers 710-740 of the flexible substrate coating apparatus 700 may be configured for performing deposition by sputtering, such as magnetron sputtering. As used herein, “magnetron sputtering” refers to sputtering performed using a magnet assembly, that is, a unit capable of a generating a magnetic field. Typically, such a magnet assembly includes a permanent magnet. This permanent magnet is typically arranged within a rotatable target or coupled to a planar target in a manner such that the free electrons are trapped within the generated magnetic field generated below the rotatable target surface. Such a magnet assembly may also be arranged coupled to a planar cathode.

Magnetron sputtering may also be realized by a double magnetron cathode, such as, but not limited to, a TwinMag™ cathode assembly. In some embodiments, the cathodes in the processing chamber may be interchangeable. Thus, a modular design of the apparatus is provided which facilitates optimizing the apparatus for particular manufacturing processes. In some embodiments, the number of cathodes in a chamber for sputtering deposition is chosen for optimizing an optimal productivity of the flexible substrate coating apparatus 700.

In some embodiments, one or some of the processing chambers 710-740 may be configured for performing sputtering without a magnetron assembly. In some embodiments, one or some of the chambers may be configured for performing deposition by other methods, such as, but not limited to, chemical vapor deposition, atomic laser deposition or pulsed laser deposition. In some embodiments, one or some of the chambers may be configured for performing a plasma treatment process, such as a plasma oxidation or plasma nitridation process.

In certain embodiments, the processing chambers 710-740 are configured to process both sides of the continuous sheet of material 750. Although the flexible substrate coating apparatus 700 is configured to process the continuous sheet of material 750, which is horizontally oriented, the flexible substrate coating apparatus may be configured to process substrates positioned in different orientations, for example, the continuous sheet of material 750 may be vertically oriented. In certain embodiments, the continuous sheet of material 750 is a flexible conductive substrate. In certain embodiments, the continuous sheet of material 750 includes a conductive substrate with one or more layers formed thereon. In certain embodiments, the conductive substrate is a copper substrate.

In certain embodiments, the flexible substrate coating apparatus 700 comprises a transfer mechanism 752. The transfer mechanism 752 may comprise any transfer mechanism capable of moving the continuous sheet of material 750 through the processing region of the processing chambers 710-740. The transfer mechanism 752 may comprise a common transport architecture. The common transport architecture may comprise a reel-to-reel system with a common take-up-reel 754 positioned in the winding module 706, the coating drum 755 positioned in the processing module 704, and a feed reel 756 positioned in the unwinding module 702. The take-up reel 754, the coating drum 755, and the feed reel 756 may be individually heated. The take-up reel 754, the coating drum 755 and the feed reel 756 may be individually heated using an internal heat source positioned within each reel or an external heat source. The common transport architecture may further comprise one or more auxiliary transfer reels 753a, 753b positioned between the take-up reel 754, the coating drum 755, and the feed reel 756. Although the flexible substrate coating apparatus 700 is depicted as having a single processing region, in certain embodiments, it may be advantageous to have separated or discrete processing regions for each individual processing chamber 710-740. For embodiments having discrete processing regions, modules, or chambers, the common transport architecture may be a reel-to-reel system where each chamber or processing region has an individual take-up-reel and feed reel and one or more optional intermediate transfer reels positioned between the take-up reel and the feed reel.

The flexible substrate coating apparatus 700 may comprise the feed reel 756 and the take-up reel 754 for moving the continuous sheet of material 750 through the different processing chambers 710-740. In one embodiment, the first processing chamber 710 and the second processing chamber 720 are each configured to deposit a portion of a metal film. The third processing chamber 730 is configured to deposit a lithium carbonate film. The fourth processing chamber 740 is configured to deposit a lithium halide film over the lithium carbonate film. In another embodiment where the continuous sheet of material 750 is a polymer material, the first processing chamber 710 is configured to deposit a copper film on the polymer material. The second processing chamber 720 is configured to deposit a portion of a metal film. The third processing chamber 730 is configured to deposit a lithium carbonate film. The fourth processing chamber 740 is configured to deposit a lithium halide film. In some embodiments, the finished negative electrode will not be collected on the take-up reel 754 as shown in the figures, but may go directly for integration with the separator and positive electrodes, etc., to form battery cells.

In one embodiment, processing chambers 710-720 are configured for depositing a thin film of lithium metal on the continuous sheet of material 750. Any suitable lithium deposition process for depositing thin films of lithium metal may be used to deposit the thin film of lithium metal. Deposition of the thin film of lithium metal may be by PVD processes, such as evaporation, a slot-die process, a transfer process, a lamination process or a three-dimensional lithium printing process. The chambers for depositing the thin film of lithium metal may include a PVD system, such as an electron-beam evaporator, a thin film transfer system (including large area pattern printing systems such as gravure printing systems), a lamination system, or a slot-die deposition system.

In one embodiment, the third processing chamber 730 is configured for depositing a lithium carbonate film on the metal film. The lithium carbonate film may be deposited using a PVD sputtering technique as described herein. In one embodiment, the fourth processing chamber 740 is configured for forming a lithium halide film on the lithium carbonate film. Any suitable lithium deposition process for depositing thin films of lithium metal may be used to deposit the thin film of lithium metal. Deposition of the thin film of lithium metal may be by PVD processes, such as evaporation, a slot-die process, a transfer process, a lamination process or a three-dimensional lithium printing process. In one embodiment, the fourth processing chamber 740 is an evaporation chamber or PVD chamber configured to deposit a lithium halide film over the continuous sheet of material 750. In one embodiment, the evaporation chamber has a processing region that is shown to comprise an evaporation source that may be placed in a crucible, which may be a thermal evaporator or an electron beam evaporator (cold) in a vacuum environment, for example.

In operation, the continuous sheet of material 750 is unwound from the feed reel 756 as indicated by the substrate movement direction shown by arrow 708. The continuous sheet of material 750 may be guided via one or more auxiliary transfer reels 753a, 753b. It is also possible that the continuous sheet of material 750 is guided by one or more substrate guide control units (not shown) that shall control the proper run of the flexible substrate, for instance, by fine adjusting the orientation of the flexible substrate.

After uncoiling from the feed reel 756 and running over the auxiliary transfer reel 753a, the continuous sheet of material 750 is then moved through the deposition areas provided at the coating drum 755 and corresponding to positions of the deposition units 712, 722, 732, and 742. During operation, the coating drum 755 rotates around axis 751 such that the flexible substrate moves in the direction of arrow 708.

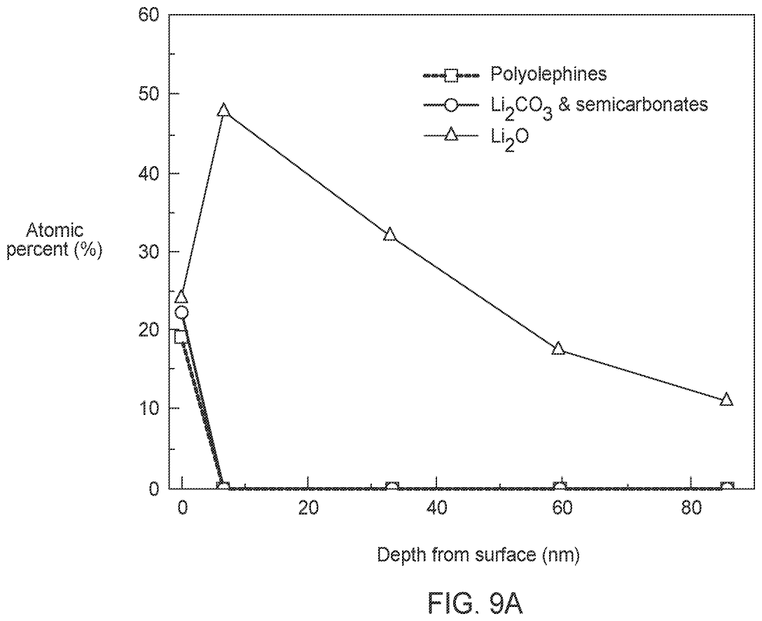

FIG. 8 is a flow diagram of a method of forming a lithium metal anode 400 using a transfer substrate. At operation 802, a second passivation layer is disposed over a transfer substrate (not shown). The second passivation layer includes a dielectric film, such as a lithium halide film 320. In one embodiment, the lithium halide film 320 is selected from LiF, LiCl, LiBr, and LiI. In one embodiment, the lithium halide film 320 is a lithium fluoride film. In one embodiment, the lithium halide film 320 is deposited on the transfer substrate by Physical Vapor Deposition (PVD), evaporation, atomic layer deposition (ALD), a slot-die process, a thin-film transfer process, or a three-dimensional lithium printing process. In one embodiment, PVD is the method for deposition of the lithium halide film 320. In one embodiment, the lithium halide film 320 is deposited using a thermal evaporation process. In one embodiment, the lithium halide film is formed by reduction of a functional layer or surface functional groups on the plastic substrate used for metal deposition. This halide/organic layer will then be present on the metal film 450 surface following lamination to the substrate 460. In one embodiment, the lithium halide film 320 has a thickness of about 15 nm or less (e.g., from about 1 nm to about 15 nm; from about 5 to about 10 nm; from about 10 nm to about 15 nm).

The transfer substrate could be flexible plastic film (e.g., polyethylene terephthalate (PET), polyethylene (PE), polypropylene (PP), polyimide (PI), etc.). In some embodiments, the transfer substrate may be coated with an organic or inorganic functional layer or layers which may be selectively transferred or aid selective transfer of metal film (e.g., PDMS, boron nitride, aluminum oxide (AlOₓ), polytetrafluoroethylene (PTFE), fluorinated ethylene propylene (FEP), perfluorooctanoic acid (PFOA), polyvinylidene (PVDF), etc.). The metal and dielectric layers are then deposited onto this plastic substrate and subsequently transferred by lamination onto the desired device architecture, such as a current collector or substrate 460 (e.g., copper (Cu) and metallized plastic such as cu on PET). In one embodiment, the transfer substrate has a thickness of 200 microns or less, such as from 5 microns to about 100 microns, from about 10 microns to about 75 microns, or from about 20 microns to about 50 microns.

At operation 804, a first passivation layer is disposed over the second passivation layer. The first passivation layer includes a lithium carbonate film 310. In one embodiment, the lithium carbonate film 310 has a thickness of about 200 nm or less (e.g., from about 5 nm to about 200 nm; from about 20 nm to about 150 nm; from about 40 nm to about 100 nm; from about 60 nm to about 80 nm). In one embodiment, the lithium carbonate film 310 (has a thickness of about 200 nm or less (e.g., from about 5 nm to about 200 nm; from about 20 nm to about 150 nm; from about 40 nm to about 100 nm; from about 60 nm to about 80 nm).

At optional operation 806, a third passivation layer is disposed over the first passivation layer. The third passivation layer includes a lithium oxide film. In one embodiment, the lithium oxide film 210 is formed by depositing an additional metal film via PVD in an oxygen-and-carbon-containing atmosphere. The lithium oxide film 210 has a thickness of 500 nanometers or less (e.g., from about 1 nm to about 400 nm; from about 25 nm to about 300 nm; from about 50 nm to about 200 nm; or from about 100 nm to about 150 nm). The lithium oxide film 210 is formed by depositing an additional metal film via PVD in an oxygen-containing atmosphere.

At operation 808, a metal film 450 is disposed over the first passivation layer. In one embodiment, the metal film 450 is the anode film 150. Optionally, the metal film is disposed over the lithium oxide film 210. Deposition of the metal film 450 may be by evaporation, a sputtering process, a slot-die process, a transfer process, or a three-dimensional lithium printing process. The chamber for depositing the metal film 450 may include a PVD system, an electron-beam evaporator, a thermal evaporator, a thin film transfer system (including large area pattern printing systems such as gravure printing systems) or a slot-die deposition system. In one embodiment, the metal film 450 has a thickness of 100 micrometers or less (e.g., from about 1 μm to about 100 μm; from about 3 μm to about 30 μm; from about 20 μm to about 30 μm; from about 1 μm to about 20 μm; or from about 50 μm to about 100 μm).

At operation 810, the films (e.g., the first passivation layer, the second passivation layer, the third passivation layer, and the metal film) are transferred from the transfer substrate to the substrate 460. In one embodiment, the substrate 460 is the anode current collector 160. In one embodiment, the substrate 460 is a continuous sheet of material. The substrate 460 includes one of aluminum (Al), copper (Cu), zinc (Zn), nickel (Ni), cobalt (Co), manganese (Mn), chromium (Cr), stainless steel, clad materials, alloys thereof, and combinations thereof. In one embodiment, the substrate 460 is perforated. Furthermore, the substrate 460 may be of any form factor (e.g., metallic foil, sheet, or plate), shape and micro/macro structure.

In some embodiments, the substrate 460 is exposed to a pretreatment process, which includes at least one of a plasma treatment or corona discharge process to remove organic materials from the exposed surfaces of the substrate 460. The pretreatment process is performed prior to film deposition on the substrate 460.

### EXAMPLES

The following non-limiting examples are provided to further illustrate implementations described herein. However, the examples are not intended to be all-inclusive and are not intended to limit the scope of the implementations described herein.

Flexible substrate coating apparatus was used to thermally evaporate metal film ranging in thickness from about 1 μm to about 20 μm onto foil substrate of thickness of about 6 μm to about 18 μm. The metal film may include a lithium metal film. Lithium was evaporated from crucibles maintained at about 650° C. The evaporation rate, monitored by a quartz crystal oscillator, was maintained between 2-4 Å/s. The foil was wound at a speed ranging from about 0.1 m/min to about 10 m/min. Following metal film deposition, the lithium coated substrate was wound past a modular gas showerhead, exposing the roll to carbon dioxide (CO₂) gas, leading to the formation of a lithium carbonate film, ranging in thickness from about 5 nm to about 20 nm. Coated rolls were unloaded from the flexible substrate coating apparatus and A5 sheets of size 15 cm×20 cm were cut and loaded into sample holders. Prepared samples were transferred to a toolset.

The toolset has process capabilities to accommodate resistive thermal evaporation, sputter deposition, electron beam evaporation, and ion assisted deposition. Lithium halide films are grown by thermal evaporation both on the lithium metal coated substrates and, on a silicon wafer. The substrate temperature was kept constant during deposition at about 25° C. The starting material was ultra-high purity single crystal lithium halide powder, which is heated to about 800° C. in an alumina crucible. The evaporation rate, monitored by a quartz oscillator, was kept at 1-2 Å/s. The vapor pressure in the deposition chamber was kept below 1 mPA. Lithium halide samples has a thickness from about 1 nm to about 200 nm.

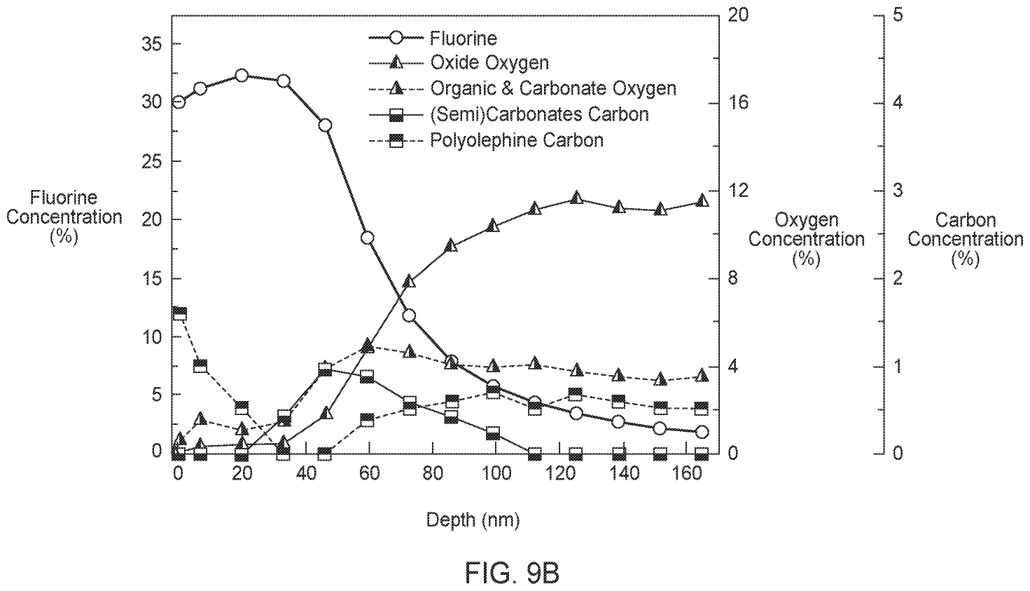

The composition of the SEI film stack was characterized using X-Ray Photoelectron Spectroscopy (XPS). Samples were sputtered in an argon plasma to generate compositional depth profiles. Results confirmed the existence of a pure lithium halide film with minimal contamination. Both the lithium carbonate film and lithium halide film exhibit low oxide and hydroxide content, as seen in FIGS. 9A and 9B. This sharply contrasts with the lithium metal without an SEI film stack, which continuously reacts with contaminants, leading to the formation of hydroxide and oxide coatings. The SEI film stack effectively stabilizes the lithium metal interface, and greatly limits undesirable oxide and hydroxide contamination and coating formation.

The effectiveness of the SEI film stack was studied by exposing the lithium metal anode to an uncontrolled environment outside of a dry room where moisture, oxygen, and nitrogen are relatively high. The lithium can retain silvery texture due to the protection of the SEI film stack from reactivity and exposure. A non-SEI film stack anode does not retain the texture and the sample turns black. However, the SEI film stack sample anode is in good condition after 5 minutes of storage. Thus, it is clear that non-SEI film stack anode shows accelerated oxidation in outside dry room ambient versus SEI film stack anode.

Coin cells were built consisting of modified lithium on copper (5 μm lithium, 18 μm copper, 1 cm²), double polymer separator (Celgard 2400) and 60 μL of 1M LiPF₆ with 2% FEC in 1:1 EC:EMC as electrolyte. Potentiostatic electrochemical impedance spectroscopy (PEIS) was conducted at 5 mV in the frequency range of about 1 MHz to about 10 mHz, 2 hours after the assembly of the cells. Direct current internal resistance (DCIR) measurements were done at currents from about 0.2 mA to about 3 mA in steps of 0.2 mA. Each current pulse is 10 seconds and there is a 15 minute rest between two pulses. The cells were cycled at 2 mA for 15 minutes each charge/discharge cycle, and the cut-off voltage was set to be 1 V. For all tests, at least 5 cells were tested to give a statistical distribution.

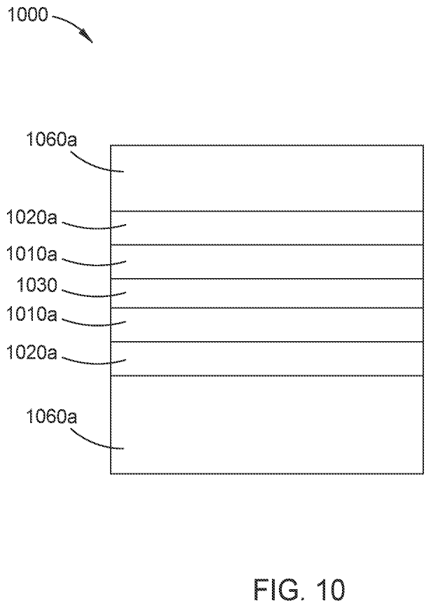

FIG. 10 illustrates a modified interface lithium metal anode 1000. The modified interface lithium metal anode 1000 includes a separator film 1030, a first side first passivation layer 1010a, a second side first passivation layer 1010b, a first side second passivation layer 1020a, a second side second passivation layer 1020b, a first side metal film 1060a, and a second side metal film 1060b. The first side and second side passivation layers 1010a, 1010b are disposed on a first side and a second side of the separator film 1030, respectively. The first side and the second side second passivation layers 1020a, 1020b are disposed on the first side and second side first passivation layers 1010a, 1010b, respectively. The first side and second side metal films 1060a, 1060b are disposed on the first side and the second side second passivation layers 1020a, 1020b, respectively. The lithium carbonate/lithium halide SEI film stack are deposited by PVD directly on to lithium metal prior to use in a deposition stripping cycle.

Then introducing elements of the present disclosure or exemplary aspects or embodiment(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to embodiments of the present disclosure, other and further embodiments of the disclosure may be devised without departing from the basic scope thereof, and the scope thereof is determined by the claims that follow.

What is claimed is:

1. An anode for a battery, comprising:
a substrate;
a metal film disposed on the substrate, wherein the metal film comprises a metal or a metal alloy; and
a film stack disposed on the metal film, the film stack comprising:
a first passivation layer disposed on the metal film, wherein the first passivation layer is lithio-philic; and
a second passivation layer disposed on the first passivation layer;
wherein the film stack is electrically insulating and ionically conductive.

2. The anode of claim 1, wherein the metal film comprises lithium.

3. The anode of claim 1, wherein the film stack is a solid electrolyte interphase.

4. The anode of claim 1, wherein the first passivation layer is a lithium carbonate film.

5. The anode of claim 1, wherein the second passivation layer is a dielectric film.

6. The anode of claim 1, further comprising a third passivation layer disposed over the metal film, wherein the first passivation layer is disposed over the third passivation layer.

7. The anode of claim 6, wherein the third passivation layer is a lithium oxide film.

8. An energy storage device, comprising:
a cathode, comprising:
a cathode current collector;
a cathode film disposed on the cathode current collector;
a separator film disposed on the cathode film; and
an anode disposed on the separator film, the anode comprising:
an anode film disposed on the separator film;
a film stack disposed on the anode film, the film stack comprising:
a first passivation layer disposed on the anode film, wherein the first passivation layer is lithio-philic; and
a second passivation layer disposed on the first passivation layer, wherein the film stack is electrically insulating and ionically conductive; and
an anode current collector disposed on the anode film, wherein the anode comprises a metal or a metal alloy.

9. The energy storage device of claim 8, wherein the anode current collector is a substrate.

10. The energy storage device of claim 8, wherein the anode film is a metal film.

11. The energy storage device of claim 8, wherein the first passivation layer is a lithium carbonate film.

12. The energy storage device of claim 8, wherein the second passivation layer is a dielectric film.

13. The energy storage device of claim 8, further comprising a third passivation layer disposed over the anode film, wherein the first passivation layer is disposed over the third passivation layer.

14. The energy storage device of claim 13, wherein the third passivation layer is a lithium oxide film.

15. A method of forming an anode for a battery, the method comprising:
disposing a metal film over a substrate, wherein the metal film comprises a metal or a metal alloy; and
disposing a film stack over the metal film, the disposing of the film stack comprising:
disposing a first passivation layer over the metal film, wherein the first passivation layer is lithio-philic; and
disposing a second passivation layer over the first passivation layer wherein the film stack is electrically insulating and ionically conductive.

16. The method of claim 15, wherein disposing the second passivation layer is performed using physical vapor deposition, evaporation deposition, atomic layer deposition, a slot-die process, a thin film transfer process, or a three-dimensional lithium printing process.

17. The method of claim 15, wherein disposing the first passivation layer is performed by exposing the metal film to carbon dioxide.

18. The method of claim 15, further comprising:
disposing a third passivation layer over the metal film, wherein the first passivation layer is disposed over the third passivation layer.

19. The method of claim 18, wherein disposing the third passivation layer is performed using physical vapor deposition.

20. The method of claim 15, further comprising:
disposing a separator film over the film stack; and
disposing a cathode over the separator film, the disposing of the cathode comprising:
disposing a cathode film over the separator film; and
disposing a cathode current collector over the cathode film.
